(19) United States
(12) Patent Application Publication
(10) Pub. No.: US 2009/0082999 A1
(43) Pub. Date: Mar. 26, 2009

(54) METHOD AND SYSTEM FOR AUTOMATICALLY DETERMINING AN OPERATING MODE OF A GENERATOR

(75) Inventors: Richard J. Rucigay, Saratoga Springs, NY (US); Christopher P. Rambosek, Acworth, GA (US); Mohit Sharma, Bangalore (IN); Douglas A. Catharine, Scotia, NY (US); Lamar Blackwell, Lithonia, GA (US); Bruce Faulk, Norcross, GA (US); Soumen De, Karnataka (IN)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/858,619

(22) Filed: Sep. 20, 2007

(51) Int. Cl. G06F 11/30; H02P 9/00

(52) U.S. Cl. 702/183; 322/99

(57) ABSTRACT

A method and system for determining the operating mode of a generator is provided. The method and system may include a generator operating mode evaluation system. The method and system may receive a plurality of generator operating data for use by the method and system to determine a generator operating mode. The method and system may provide a notification on the generator operating mode. The method and system may also store a plurality of generator operating mode data.

### BACKGROUND OF THE INVENTION

The present invention relates to generators; and more particularly to a method and system for automatically determining an operating mode of a generator.

Accurately determining the operating mode may ensure the safe and reliable operation of the generator; and may also prevent a failure of the generator and/or other power plant equipment.

Power plant operators usually employ some form of monitoring and diagnostics (M&D) system, or the like. An M&D system may assist with the operation of the power plant machine, which may be coupled to a generator. Currently known M&D systems tend to focus on the collection of the power plant machine operating data. However, collecting generator operating data generator may useful for determining the generator operating mode; and also for comparing similar operating data and previous occurrences when the generator operated in a specific generator operating mode.

There are a few problems with the currently know systems. The currently known systems may not automatically determine, in real-time, the operating mode of a generator. The currently known systems require an off-site technical expert to evaluate the operating data and determine the generator operating mode. The currently known systems generally do not allow for comparing current generator operating data with stored generator operating data; which relates to a specific generator operating mode. The currently known systems may not automatically generate a notification indicating the current generator operating mode.

For the foregoing reasons, there is a need for a method and system for automatically determining a generator operating mode. The method should not require off-site technical expert to determine the generator operating mode. The method should allow for the collection and comparison of generator operating data. The method should allow for integration with an existing M&D system. The method should not require an off-site technical expert to determine whether a performance issue may exist. The method should automatically provide a notification of the current generator operating mode.

### BRIEF DESCRIPTION OF THE INVENTION

In accordance with an embodiment of the present invention, a method of automatically determining the operating mode of at least one generator, the method comprising: providing an operating mode evaluation system, wherein the operating mode evaluation system is located on-site where the at least one generator is operated; receiving a plurality of operating data corresponding to the at least one generator; determining a generator operating mode; providing a notification on the generator operating mode; and determining whether to store a plurality of generator operating mode data.

In accordance with an alternate embodiment of the present invention, A method of automatically determining the operating mode of at least one generator, the method comprising: providing an operating mode evaluation system, wherein the operating mode evaluation system is located on-site where the at least one generator is operated and wherein the operating mode evaluation system integrates with at least one monitoring and diagnostic system; receiving a plurality of operating data corresponding to the at least one generator; wherein the plurality of operating data comprises: shaft speed; generator output; generator volts; generator breaker status, and combinations thereof; determining a generator operating mode; wherein the generator operating mode comprises at least one transient condition and at least one steady state condition; providing a notification on the generator operating mode; and determining whether to store a plurality of generator operating mode data.

In accordance with another alternate embodiment, a system for automatically determining the operating mode of at least one generator, the system comprising: means for providing an operating mode evaluation system; means for receiving a plurality of operating data; means for determining a generator operating mode; means for providing a notification on the generator operating mode; and means for determining whether to store a plurality of generator operating mode data.

### BRIEF DESCRIPTION OF THE DRAWINGS

FIG. 1 is a schematic illustrating the environment in which an embodiment of the present invention operates.

FIG. 2 is a flowchart illustrating an example of a method of automatically determining a generator operating mode in accordance with an embodiment of the present invention.

FIG. 3 is a block diagram of an exemplary system for automatically determining a generator operating mode in accordance with an embodiment of the present invention.

### DETAILED DESCRIPTION OF THE INVENTION

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

An embodiment of the present invention takes the form of an application and process that has the technical effect of automatically determining the operating mode of at least one generator, (generator operating mode or the like). The present invention can be applied to many types of generators, including generators coupled to various forms of turbomachines, such as a gas turbine, a steam turbine, or the like; and combinations thereof.

A generator operating mode generally provides a real-time operating status of the generator during operation. As describe below, there may be a plurality of generator operating modes. An M&D system may collect generator operating mode, while the generator may be in operation. An embodiment of the present invention may utilize the operating data to determine the generator operating mode.

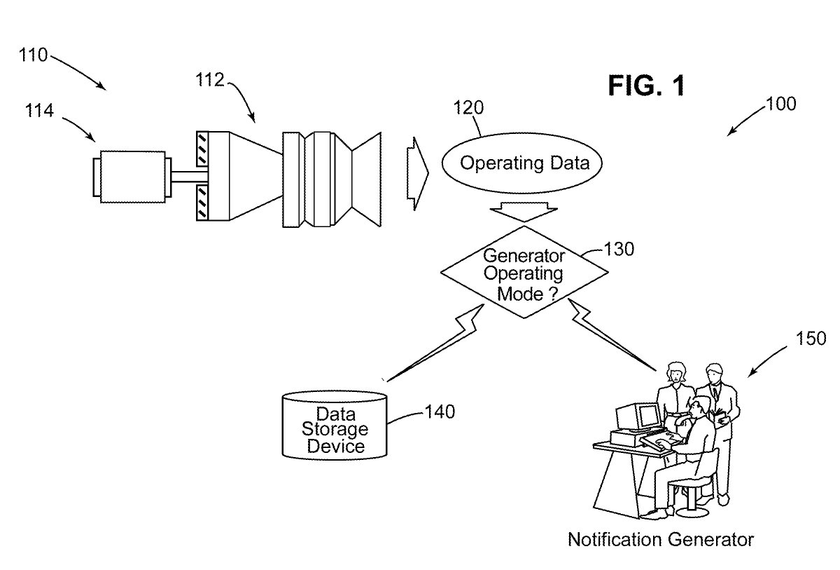

Referring now to the Figures, where the various numbers represent like elements throughout the several views, FIG. 1 is a schematic illustrating the environment in which an embodiment of the present invention operates. FIG. 1 illustrates a power plant site 100 comprising a power plant machine 110; a plurality of operating data 120; a generator operating mode evaluator 130; a data storage device 140; and a notification generator 150.

The power plant machine 110 may comprise a combustion turbine 112 coupled to a generator 114. The power plant site 100 may comprise at least one control system or the like (not illustrated) which may receive the plurality of operating data 120 from the at least one power plant machine 110. The plurality of operating data 120 may comprise a plurality of data points including: shaft speed; generator output; generator volts; generator breaker status; combinations thereof; and other operating data that may be used in determining the generator operating mode of the at least one generator 114.

The plurality of operating data 120 may be transmitted to at least one generator operating mode evaluator 130, which may have the form of a continuous diagnostic engine (not illustrated), or the like. The generator operating mode evaluator 130 may apply at least one math engine, or the like, to the plurality of operating data 120 to determine the generator operating mode.

The plurality of operating data 120 may then be transmitted to at least one data storage device 140, which may store the plurality of operating data 120. The data storage device 140 may be located at the power plant site 100; or in alternate embodiment of the present invention, the data storage device 140 may be located off the site where the power plant machine 110 is located.

The notification generator 150 may automatically generate a notification of the current generator operating mode. The present invention may also allow for the notification to be automatically sent to the operator of the generator. The present invention may allow for the notification to be automatically sent to a third-party support system. Here, the third-party support system may be contacted if the generator operating mode evaluator 130 determines that a potential issue may exist with the generator 114.

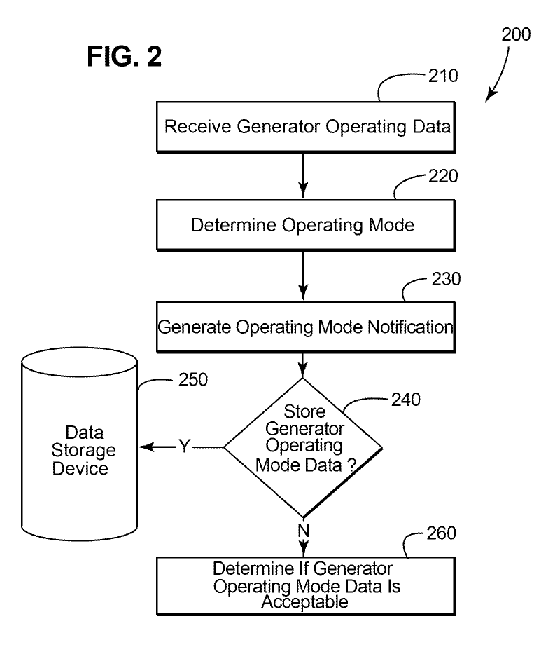

Referring now to FIG. 2, which is a flowchart illustrating an example of a method 200 of automatically determining a generator operating mode in accordance with an embodiment of the present invention. In step 210, the method 200 may receive a plurality of operating data 120 from at least one power plant machine 110 (not illustrated in FIG. 2). An embodiment of the present invention may allow for receiving the plurality of operating data 120 from multiple generators 114. For example, but not limiting of, the method 200 in step 210 may receive the plurality of operating data 120 from a gas turbine coupled to a first generator, and a steam turbine coupled to a second generator.

The plurality of operating data 120 may be received at different sampling rates, or the like, such as, but not limiting of the invention, one data point per second (1/sec) or one data point per thirty seconds ( 1/30 see). Generally, during the operation of a power plant machine 110, certain operating data points may be used for monitoring purposes, while other operating data points may be used for controlling or other purposes that require a higher sampling rate. Here, to conserve the storage space which may be used to store the operating data 120, the operating data points used for monitoring may be received at a slower sampling rate, such as 1/30 sec. Furthermore, the operating data points used for controlling, may be received at a higher sampling rate, such as 1/sec. For example, but not limiting of, an operating data point used for monitoring the generator volts may be received at a slower sampling rate, such as 1/30 sec; and an operating data point used for controlling the shaft speed may be received at a higher sampling rate, such as 1/sec.

In step 220, the plurality of operating data 120 received in step 210 may be used to determine the generator operating mode. An embodiment of the present invention may utilize at least one continuous diagnostic engine (not illustrated in FIG. 2) to determine the generator operating mode. Generally, the continuous diagnostic engine may, in real-time use a portion of the plurality of operating data 120 to perform at least one calculation to determine the current generator operating mode. The portion of the plurality of operating data 120 may include analog and digital data points. For example, but not limiting of, the continuous diagnostic engine may use data representing: a generator shaft speed; generator output; generator volts; generator breaker status; and combinations thereof.

The continuous diagnostic engine may include an algorithm, or the like, which provides a mode value corresponding to the calculated generator operating mode. An embodiment of the present invention may provide a reference table that provides a description of each mode value. For example, but not limiting of, a reference table may include the descriptions shown in Table 1:

TABLE 1

| Mode Value | Generator Mode | Generator Condition |
|---|---|---|
| 1 | Unknown | Transient |
| 2 | Off | Transient |
| 3 | Turning Gear | Transient |
| 4 | Acceleration/Startup | Transient |
| 5 | Acceleration/Startup | Steady State |
| 6 | Full Speed No Load | Transient/Steady State |
| 7 | Loaded | Transient |
| 8 | Loaded | Steady State |
| 9 | Deceleration | Transient |

A transient condition, as listed in Table 1, may be considered a condition where temperature sensors detect temperature variations within the generator outside of a temperature variation limit. A transient condition may also be a condition where a change in the generator shaft speed occurs outside of a speed variation limit. A transient condition may also be considered a condition where a change in the generator load/output occurs outside of a load/output stability limit.

A steady state condition, as listed in Table 1, may be considered a condition where temperature sensors detect temperature variations within the generator within a temperature variation limit. A steady state condition may also be a condition where a change in the generator shaft speed occurs within a speed variation limit. A steady state condition may also be a condition where a change in the generator load/output occurs within a load/output stability limit.

The following are descriptions of each mode value shown in Table 1.

Mode 1 may represent an Unknown generator mode; the continuous diagnostic engine, or an embodiment of the present invention, may select this mode as a default mode, or the like. The continuous diagnostic engine may, for example, but not limiting of, select Unknown if the method 200 is not receiving a plurality of operating data 120.

Mode 2 may represent an Off generator mode; the continuous diagnostic engine, or an embodiment of the present invention, may select this mode if the power plant machine 110 is not in operation.

Mode 3 may represent a Turning Gear generator mode; which may be a transient condition. The continuous diagnostic engine, or an embodiment of the present invention, may select this mode when the shaft speed is less than or equal to 1% of the rated shaft speed.

Mode 4 may represent an Acceleration/Startup generator mode; which may be a transient condition. The continuous diagnostic engine, or an embodiment of the present invention, may select this mode when the shaft speed is greater than 1% speed but less than 95% speed.

Mode 5 may represent an Acceleration/Startup generator mode occurring; which may be a steady-state condition. The continuous diagnostic engine, of an embodiment of the present invention, may select this mode when the shaft speed is greater than 1% speed but less than 95% speed.

Mode 6 may represent a Full Speed No Load generator mode. The continuous diagnostic engine, or an embodiment of the present invention, may select this mode when the shaft speed is greater than 95% speed and the generator is exporting (loaded) no power. Mode 6 may apply when the generator is operating in either a transient or a steady state condition.

Mode 7 may represent a Loaded generator mode when the generator is in a transient condition. The continuous diagnostic engine, or an embodiment of the present invention, may select this mode when the power plant machine 110 is increasing the generator output; such as, but not limiting of, to the rated base load.

Mode 8 may represent a Loaded generator mode when the generator is in a steady-state condition. The continuous diagnostic engine, or an embodiment of the present invention, may select this mode when the power plant machine 110 is operating at a designated load set point; such as, but not limiting of, to the rated base load.

Mode 9 may represent a Deceleration generator mode when the generator is in a transient condition. The continuous diagnostic engine, or an embodiment of the present invention, may select this mode when the power plant machine 110 is decreasing the generator shaft speed; such as, but not limiting of, during a shut down sequence.

An embodiment of the present invention may allow the user the flexibility of defining the generator operating modes. Hence, the Modes 1-9 listed in Table 1 may be modified to suit the specific needs of a user. For example, but not limiting of, a user may only desire 6 generator operating modes.

An embodiment of the present invention may also allow a user to customize the continuous diagnostic engine to account for site specific and/or generator specific conditions. For example, but not limiting of, the continuous diagnostic engine may include at least one file having site specific constants and a separate file containing unit specific constants; both of which may be utilized by the algorithm, or the like, of the continuous diagnostic engine.

Returning to FIG. 2, the method 200, in step 230 may generate a notification indicating the current generator operating mode. The notification may be automatically generated and automatically transmitted to a support system. The support system may be a third-party service of which the operator of the power plant machine 110 subscribes. For example, but not limiting of, the support system may be provided by the original equipment manufacturer (OEM), or the like. In an alternate embodiment of the present invention, the generator operating mode notification may be transmitted to the operator of the power plant machine 110.

In step 240, the method 200 may determine whether to store a portion of the plurality of operating data 110 that was used to determine the generator operating mode. In an embodiment of the present invention a user may select which of the plurality of operating data 110 to store. For example, but not limiting of, a user may desire to store the shaft speed data covering the period when the generator operating mode changed from a mode value 3 to a mode value 4, as shown in Table 1. If a portion of the plurality of operating data 110 is to be stored, then the method 200 may proceed to step 250; otherwise the method 200 may proceed to step 260.

In step 250, the plurality of operating data 120 may be transmitted to at least one data storage device 140 (illustrated in FIG. 1). An embodiment of the present invention may allow for a plurality of data storage devices 140. For example, but not limiting of, a separate data storage device 140 may be designated for each generator 114 on a power plant site 100.

In step 260, the method 200 may determine if the current generator operating mode may be appropriate under the current plurality of operating data 120. Here the support system, for a specific generator operating mode, may compare previously stored operating data 120 with current operating data 120. An embodiment of the present invention may allow for the operator of the power plant machine 110 to perform the aforementioned comparison.

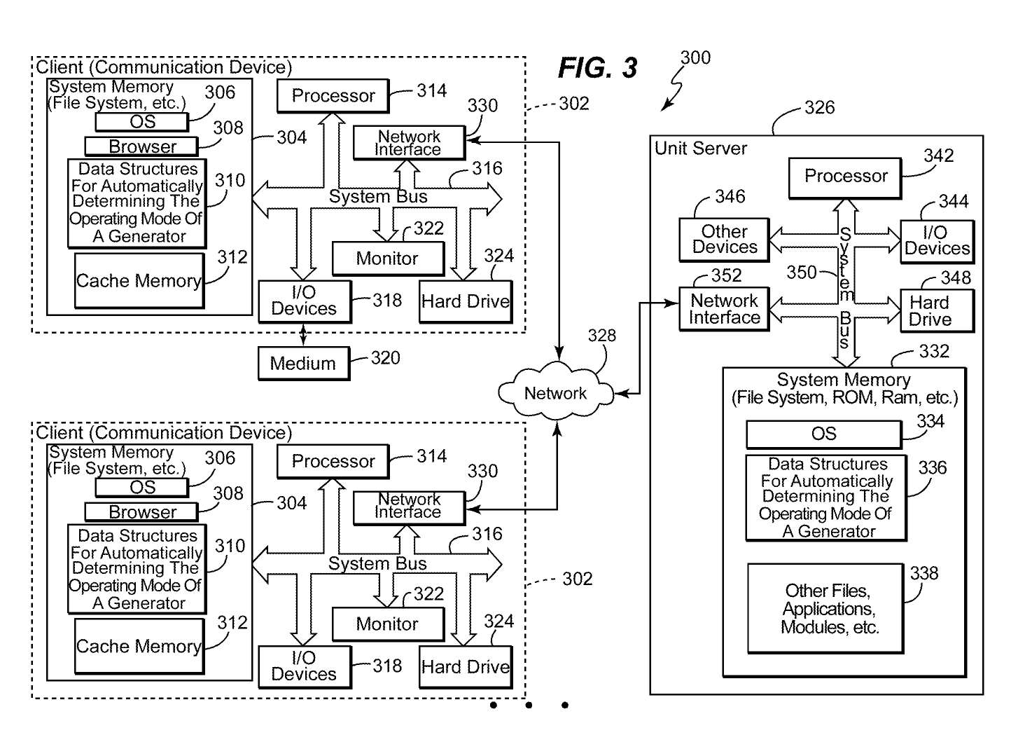

Referring now to FIG. 3, which is a step diagram of an exemplary system 300 for determining the generator operating mode of at least one generator 114 in accordance with an embodiment of the present invention. The elements of the method 200 may be embodied in and performed by the system 300. The system 300 may include one or more user or client communication devices 302 or similar systems or devices (two are illustrated in FIG. 3). Each communication device 302 may be for example, but not limited to, a computer system, a personal digital assistant, a cellular phone, or similar device capable of sending and receiving an electronic message.

The communication device 302 may include a system memory 304 or local file system. The system memory 304 may include for example, but is not limited to, a read only memory (ROM) and a random access memory (RAM). The ROM may include a basic input/output system (BIOS). The BIOS may contain basic routines that help to transfer information between elements or components of the communication device 302. The system memory 304 may contain an operating system 306 to control overall operation of the communication device 302. The system memory 304 may also include a browser 308 or web browser. The system memory 304 may also include data structures 310 or computer-executable code to determine the generator operating mode that may be similar or include elements of the method 200 in FIG. 2

The system memory 304 may further include a template cache memory 312, which may be used in conjunction with the method 200 in FIG. 2 to determine the generator operating mode.

The communication device 302 may also include a processor or processing unit 314 to control operations of the other components of the communication device 302. The operating system 306, browser 308, data structures 310 may be operable on the processor 314. The processor 314 may be coupled to the memory system 304 and other components of the communication device 302 by a system bus 316.

The communication device 302 may also include multiple input devices (I/O), output devices or combination input/output devices 318. Each input/output device 318 may be coupled to the system bus 316 by an input/output interface (not shown in FIG. 3). The input and output devices or combination I/O devices 318 permit a user to operate and interface with the communication device 302 and to control operation of the browser 308 and data structures 310 to access, operate and control the software to determine the generator operating mode. The I/O devices 318 may include a keyboard and computer pointing device or the like to perform the operations discussed herein.

The I/O devices 318 may also include for example, but are not limited to, disk drives, optical, mechanical, magnetic, or infrared input/output devices, modems or the like. The I/O devices 318 may be used to access a medium 320. The medium 320 may contain, store, communicate, or transport computer-readable or computer-executable instructions or other information for use by or in connection with a system, such as the communication devices 302.

The communication device 302 may also include or be connected to other devices, such as a display or monitor 322. The monitor 322 may be used to permit the user to interface with the communication device 302.

The communication device 302 may also include a hard disk drive 324. The hard drive 324 may be coupled to the system bus 316 by a hard drive interface (not shown in FIG. 3). The hard drive 324 may also form part of the local file system or system memory 304. Programs, software, and data may be transferred and exchanged between the system memory 304 and the hard drive 324 for operation of the communication device 302.

The communication device 302 may communicate with a remote server 326 and may access other servers or other communication devices similar to communication device 302 via a network 328. The system bus 316 may be coupled to the network 328 by a network interface 330. The network interface 330 may be a modem, Ethernet card, router, gateway, or the like for coupling to the network 328. The coupling may be a wired or wireless connection. The network 328 may be the Internet, private network, an intranet, or the like.

The server 326 may also include a system memory 332 that may include a file system, ROM, RAM, and the like. The system memory 332 may include an operating system 334 similar to operating system 306 in communication devices 302. The system memory 332 may also include data structures 336 for to determining the generator operating mode. The data structures 336 may include operations similar to those described with respect to the method 200 for determining the generator operating mode. The server system memory 332 may also include other files 338, applications, modules, and the like.

The server 326 may also include a processor 342 or a processing unit to control operation of other devices in the server 326. The server 326 may also include I/O device 344. The I/O devices 3 may be similar to I/O devices 318 of communication devices 302. The server 326 may further include other devices 346, such as a monitor or the like to provide an interface along with the I/O devices 344 to the server 326. The server 326 may also include a hard disk drive 348. A system bus 350 may connect the different components of the server 326. A network interface 352 may couple the server 326 to the network 328 via the system bus 350.

The flowcharts and step diagrams in the Figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

2. The method of claim 1, wherein the plurality of operating data comprises: shaft speed; generator output; generator volts; generator breaker status; and combinations thereof.

3. The method of claim 1, wherein the step of determining a generator operating mode further comprises utilizing at least one continuous diagnostic engine.

4. The method of claim 1, wherein the generator operating mode further comprises at least one transient condition.

5. The method of claim 4, wherein the at least one transient condition comprises: an unknown mode; an off mode; a turning gear mode; a start-up mode; a full speed no load mode; a loading mode; a deceleration mode; and combinations thereof.

6. The method of claim 1, wherein the generator operating mode further comprises at least one steady state condition.

7. The method of claim 6, wherein the at least one steady state condition comprises: an acceleration mode; a full speed no load mode; a loaded mode; and combinations thereof.

8. The method of claim 3 further comprising receiving by the continuous diagnostic engine a plurality of operating data corresponding to the at least one generator; and the continuous diagnostic engine determining a generator operating mode.

9. The method of claim 1, wherein the step of providing the operating mode evaluation system further comprises integrating the operating mode evaluation system with at least one monitoring and diagnostic system.

10. The method of claim 1, further comprising the steps of:
retrieving stored generator operating mode data; and
comparing the stored generator operating mode data with the generator operating mode data.

11. A method of automatically determining the operating mode of at least one generator, the method comprising:
providing an operating mode evaluation system, wherein the operating mode evaluation system is located on-site where the at least one generator is operated and wherein the operating mode evaluation system integrates with at least one monitoring and diagnostic system;
receiving a plurality of operating data corresponding to the at least one generator; wherein the plurality of operating data comprises: shaft speed; generator output; generator volts; generator breaker status; and combinations thereof;
determining a generator operating mode; wherein the generator operating mode comprises at least one transient condition and at least one steady state condition;
providing a notification on the generator operating mode; and
determining whether to store a plurality of generator operating mode data.

12. The method of claim 11, wherein the step of determining a generator operating mode further comprises utilizing at least one continuous diagnostic engine.

13. The method of claim 11, wherein the at least one transient condition comprises: an unknown mode; an off mode, a turning gear mode; a start-up mode; a full speed no load mode; a loading mode; a deceleration mode; and combinations thereof.

14. The method of claim 11, wherein the at least one steady state condition comprises: an acceleration mode; a full speed no load mode; a loaded mode; and combinations thereof.

15. The method of claim 11, further comprising receiving by the continuous diagnostic engine a plurality of operating data corresponding to the at least one generator; and the continuous diagnostic engine determining a generator operating mode.

16. The method of claim 11, further comprising the steps of:
retrieving stored generator operating mode data; and
comparing stored generator operating mode data with the generator operating mode data.

17. A system for automatically determining the operating mode of at least one generator, the system comprising:
means for providing an operating mode evaluation system;
means for receiving a plurality of operating data;
means for determining a generator operating mode;
means for providing a notification on the generator operating mode; and
means for determining whether to store a plurality of generator operating mode data.

18. The system of claim 17, wherein the means for determining the generator operating mode further comprises means for utilizing at least one continuous diagnostic engine.

19. The system of claim 18, further comprising means for receiving by the continuous diagnostic engine a plurality of operating data corresponding to the at least one generator; and the continuous diagnostic engine further comprising means for determining the generator operating mode.

20. The system of claim 17, further comprising:
means for retrieving stored generator operating mode data; and
means for comparing stored generator operating mode data with the current generator operating mode data.
